(19) United States
(12) Patent Application Publication
(10) Pub. No.: US 2026/0218055 A1
(43) Pub. Date: Jul. 30, 2026

(54) SURFACE-ACTIVE AGENT

(71) Applicant: Econic Technologies Ltd., Macclesfield, Cheshire (GB)

(72) Inventors: Michael KEMBER, Macclesfield, Cheshire (GB); Anthea BLACKBURN, Macclesfield, Cheshire (GB)

(21) Appl. No.: 19/146,766

(22) PCT Filed: Jan. 24, 2024
(86) PCT No.: PCT/EP2024/051682

§ 371 Date: Jul. 9, 2025

(30) Foreign Application Priority Data
Jan. 25, 2023 (GB) 2301055.6

(51) Int. Cl. C09K 23/42

(52) U.S. Cl. CPC C09K 23/42

(57) ABSTRACT

A surface-active agent comprising a polycarbonate block polyether of the formula I:

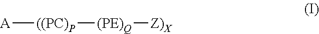

wherein:
   A is derived from a polyfunctional starter compound;
   PC represents a carbonate block with P repeat units of formula:

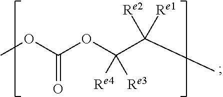

wherein:
   R^{e1}, R^{e2}, R^{e3}, and R^{e4} are all H; or
   one of R^{e1}, R^{e2}, R^{e3}, and R^{e4} is methyl, ethyl, propyl, butyl, or an ether, ester or carbonate group, and the remaining three of R^{e1}, R^{e2}, R^{e3}, and R^{e4} are all H;
   PE represents a polyether block with Q repeat units of formula:

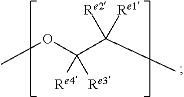

wherein:
   R^{e1′}, R^{e2′}, R^{e3′}, and R^{e4′} are all H; or
   one of R^{e1′}, R^{e2′}, R^{e3′}, and R^{e4′} is methyl, ethyl, propyl, butyl, or an ether, ester or carbonate group, and the remaining three of R^{e1′}, R^{e2′}, R^{e3′}, and R^{e4′} are all H;
   Z is OH, O—R, O—C(O)—R or O—C(O)—O—R;
wherein each R is independently an optionally substituted (including with heteroatoms) straight or branched chain or cyclic alkyl, aryl, aralkyl, alkaryl, alkenyl, alkenaryl, or aralkenyl group;
wherein the value of each P and the value of each Q are each independently from 1 to 50; and
   X is 2 or more.

### FIELD

The present invention relates to surface-active agents, to processes for making them, and to certain applications.

### BACKGROUND

Non-ionic surfactants are typically produced from petrochemical raw materials. Examples include propylene and ethylene oxides, which both produce significant amounts of CO₂ emissions in their manufacture. As a consequence, greener alternatives for these raw materials are being sought.

In the case of epoxide based non-ionic surfactants, particularly those containing propylene oxide and those of higher molecular weight, biodegradation is not readily observed, contrary to the requirements of worldwide legislation.

Surface-active agents combining polyether and polycarbonate blocks are known in the art of oil extraction. WO2010/062703A1 and WO2015/031348A1 describe polymer compositions and supercritical CO₂ solutions of a potentially wide range of such polymers to assist with oil extraction. Such solutions form an emulsion waste product with water to assist with the oil extraction. There is no indication of any solubility in water or the use of such a water soluble polymer. The polymer compositions are designed to dissolve in liquid or supercritical CO₂ applications.

WO2010/062703A1 mentions examples with a polyether block and a polycarbonate block but such is not exemplified, and the blocks are not fully characterised or tested. In the general structure provided for the polymer composition, L is used as a linker moiety or a covalent bond between the hydrophobic portion and the hydrophilic oligomer (B).

WO2015/031348A1 describes polycarbonate blocks of the type Y—O-APC—O—CₓH_{y} wherein APC is a polycarbonate and CₓH_{y} is a saturated or unsaturated hydrocarbon. The terminal group Y can be H or several other groups such as a polyether chain, but the latter is not exemplified or further identified.

EP0338396A1 describes a polyether polycarbonate surface-active agent comprise of: a hydrophilic portion comprising a polymer selected from the group consisting of a polyoxyalkylene polyether, a saccharide, a saccharide polyoxyalkylenate, a polycarbonate having a carbon dioxide content of from about 1 to 15 molar percent and mixtures thereof and a hydrophobic portion comprising alkylene and carbonate units arranged in alternating or random order to form a poly(alkylene carbonate) having a total carbon dioxide content of from about 25 to 50 molar percent and a total molecular weight of from 300 to 10,000. The hydrophobic portion is bonded to the hydrophilic portion at each side of a reactive hydrogen. The surface active agent is prepared by polymerising the hydrophilic portion with the hydrophobic portion in a weight ratio of about 10:90 to 90:10.

US2021/309801A1 discloses degradable ethylene oxide-based copolymers manufactured via boron-activated copolymerization of ethylene oxide monomers with carbon dioxide and their use as surfactants. Certain tri-block amphiphilic compounds are reported.

WO2022/096889A1, WO2020/222019A1, WO2020/222018A1, WO2021/176211A1 and WO2021/176212A1 disclose polyol block copolymer compositions and processes for producing them.

U.S. Pat. No. 4,382,014A describes a process for producing a polyether carbonate surface-active material having hydrocarbon residue at the terminal thereof. The active hydrogen-containing compound has a hydrocarbon residue containing 4 or more carbon atoms and the five-membered ring carbonic acid ester are telomerized in the presence of an ate-complex of a metal of Group II, III or IV of the periodic table having at least two alkoxy groups.

U.S. Pat. No. 4,488,982A describes surfactants prepared by reacting a monofunctional initiator with an alkylene carbonate or with an alkylene oxide and carbon dioxide to form polyether polycarbonate materials.

US2019/0382528A1 describes a method for preparing a high molecular weight polyether carbonate, by reacting an epoxide and carbon dioxide in the presence of a bimetallic complex catalyst and a double metal cyanide (DMC) catalyst.

Our co-pending application WO2023072843A1 discloses a surface-active agent comprising a polycarbonate block polyether of the formula Z¹—(PC)_{P}—(PE)_{Q}-Z² which may be manufactured by reacting carbon dioxide and an epoxide in the presence of a carbonate catalyst, and a monofunctional starter compound to form a polycarbonate compound and subsequently reacting the polycarbonate compound with an epoxide and an ether catalyst to produce the polycarbonate block polyether.

It would be beneficial to replace current wholly petrochemical non-ionic surfactants with more sustainable alternatives that incorporate a portion of abundant and cheaper captured CO₂ and could be made from a single epoxide feed, such as ethylene oxide, which can also be produced sustainably. The incorporation of CO₂ into these co-polymers offers new, beneficial properties to the surfactant, including the opportunity to enhance biodegradation. The incorporation of CO₂ containing blocks can enhance the biodegradability of such surfactants, even at longer chain lengths.

It would also be beneficial to provide amphiphilic surfactants with a high degree of adaptability as concerns hydrophobicity vs hydrophilicity and consequent ability to target particular end-use applications by providing a range of properties, and a greater degree of control over macromolecular symmetry than has hitherto been achievable.

### SUMMARY

According to a first aspect of the present invention there is provided a surface-active agent comprising a polycarbonate block polyether of the formula I:

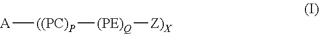

wherein:
   A is derived from a polyfunctional starter compound;
   PC represents a carbonate block with P repeat units of formula:

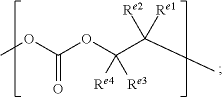

wherein:
   R^{e1}, R^{e2}, R^{e3}, and R^{e4} are all H; or
   one of R^{e1}, R^{e2}, R^{e3}, and R^{e4} is methyl, ethyl, propyl, butyl, or an ether, ester or carbonate group, and the remaining three of R^{e1}, R^{e2}, R^{e3}, and R^{e4} are all H;
   PE represents a polyether block with Q repeat units of formula:

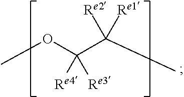

wherein:
   R^{e1′}, R^{e2′}, R^{e3′}, and R^{e4′} are all H; or
   one of R^{e1′}, R^{e2′}, R^{e3′}, and R^{e4′} is methyl, ethyl, propyl, butyl, or an ether, ester or carbonate group, and the remaining three of R^{e1′}, R^{e2′}, R^{e3′}, and R^{e4′} are all H;
   Z is OH, O—R, O—C(O)—R or O—C(O)—O—R;
wherein each R is independently an optionally substituted (including with heteroatoms) straight or branched chain or cyclic alkyl, aryl, aralkyl, alkaryl, alkenyl, alkenaryl, or aralkenyl group; wherein the value of each P and the value of each Q are each independently from 1 to 50; and
   X is 2 or more.

Preferably Z is OH or OMe, most preferably OH.

Preferably the value of each P and the value of each Q are each independently from 1 to 15.

In the present invention the polycarbonate block acts as a hydrophobe and the polyether block acts as a hydrophile. The use of a polyfunctional starter compound yields multiple (at least 2) amphiphilic chains pendant from the root moiety of the starter compound.

It will be apparent that when a difunctional starter (e.g. a diol) is selected then in that case X is 2.

Selection of a trifunctional starter (e.g. a triol) will cause X to be 3, and so on.

Preferably X is 2.

There is also provided a process for producing a surface-active agent according to the first aspect of the invention the method comprising the steps of (i) reacting carbon dioxide and an epoxide in the presence of a carbonate catalyst, and a polyfunctional starter compound to form a polycarbonate compound and (ii) reaction of the polycarbonate compound of step (i) with an epoxide and an ether catalyst to produce the surface-active agent according to the first aspect of the invention.

There is also provided a process for producing a surface-active agent according to the first aspect of the invention in a multiple reactor system; the system comprising a first and second reactor wherein a first reaction takes place in the first reactor and a second reaction takes place in the second reactor; wherein the first reaction is the reaction of a carbonate catalyst with CO₂ and epoxide, in the presence of a polyfunctional starter compound, and optionally a solvent, to produce a polycarbonate compound and the second reaction is the semi-batch or continuous reaction of an ether catalyst with the polycarbonate compound of the first reaction and epoxide to produce the surface-active agent according to the first aspect of the invention.

In a PC chain comprising multiple Re groups, individual Re groups may be different in different blocks of the chain. In a PE chain comprising multiple Re′ groups, individual Re′ groups may be different in different blocks of the chain.

For example, if in the aforesaid processes in accordance with the invention a mixture of propylene and ethylene oxide is used as epoxide in the first reaction then in some blocks of the PC chain each Re will be H (ethylene oxide being the reagent generating such a PC block); whereas in other blocks of the PC chain one of the Re groups will be methyl (propylene oxide being the reagent generating such a PC block). The same applies mutatis mutandis in relation to the PE chain.

Also provided in accordance with the invention is the use of the aforesaid surface-active agents: as agrichemical, cosmetic or pharmaceutical adjuvants; for the preparation low-foaming detergents/cleaners, institutional cleaning & sanitation products, industrial cleaning products, personal care products, adhesives, metal working fluids, paints & coatings, textiles, water treatment coatings, and in the processing of foods & beverages.

### DESCRIPTION OF EMBODIMENTS

Preferably the surface-active agent has greater than 5 wt % CO₂ incorporation, greater than 10 wt % CO₂ incorporation, more typically, greater than 15 wt % CO₂ incorporation, greater than 20 wt % CO₂ incorporation, or greater than 21 wt % CO₂ incorporation. Preferably the surface-active agent has 5 to 40 wt % CO₂ incorporation, 10 to 40 wt % CO₂ incorporation, 15 to 40 wt % CO₂ incorporation, 20 to 40 wt % CO₂ incorporation, typically, 10 to 35 wt % CO₂ incorporation, more typically, 15 to 30 wt % CO₂ incorporation.

It will be appreciated that the carbonate block of the co-polymer is hydrophobic and the ether blocks are hydrophilic. Tailoring the relative ratios of the two blocks will change the properties of the co-polymer to result in surface-active agents that can be adapted for use in water-in-oil and oil-in-water applications.

According to the present invention there is provided a surface-active agent comprising a polycarbonate block polyether of the formula I having a P:Q ratio adapted to provide the surface-active agent with amphiphilicity suitable for an oil-in-water application.

Also according to the present invention there is provided a surface-active agent comprising a polycarbonate block polyether of the formula I having a P:Q ratio adapted to provide the surface-active agent with amphiphilicity suitable for a water-in-oil application.

The epoxide used in the production of both the polycarbonate and polyether sections is independently selected from ethylene oxide (EO), propylene oxide (PO), butylene oxide, pentylene oxide, hexylene oxide, glycidyl ethers, glycidyl esters or glycidyl carbonates, or a mixture of two or more thereof. Preferably in generation of the polycarbonate block the epoxide is ethylene oxide, propylene oxide, butylene oxide or a mixture thereof, preferably ethylene oxide or propylene oxide. Preferably in generation of the polyether block the epoxide is ethylene oxide or propylene oxide or a mixture thereof, preferably ethylene oxide or propylene oxide, typically ethylene oxide.

It will also be appreciated that when a mixture of epoxides is used the epoxides will typically be statistically distributed along the polymer backbone.

Thus, when a mixture of epoxides is used the polycarbonate and the polyether blocks respectively may be referred to as a random copolymer or a statistical copolymer.

The identity of R^{e1}, R^{e2}, R^{e3}, R^{e4}, R^{e1′}, R^{e2′}, R^{e3′}, and R^{e4′} will depend on the nature of the epoxide used to prepare the polycarbonate or polyether. However, when one of R^{e1} to R^{e4} or one of R^{e1′} to R^{e2′} is methyl, ethyl, propyl, butyl, or an ether, ester or carbonate group the remaining three groups are H. Preferably R^{e1}, R^{e2}, R^{e3}, R^{e4}, R^{e1′}, R^{e2′}, R^{e3′}, and R^{e4′} are H.

It will also be appreciated that if a mixture of epoxides are used, then each occurrence of R^{e1} and/or R^{e2} (or R^{e3} and/or R^{e4}, R^{e1′} and/or R^{e2′} and R^{e3′} and/or R^{e4′}) may not be the same, for example if a mixture of ethylene oxide and propylene oxide are used in the PC block, R^{e1} (or R^{e}a) may be independently hydrogen or methyl, and R^{e2} (or R^{e4}) may be independently hydrogen or methyl.

The skilled person will understand that when the epoxide is asymmetric, the adjacent epoxide monomer units in the backbone may be head-to-tail linkages, head-to-head linkages, or tail-to-tail linkages.

Preferably, the surface-active agent has a molecular weight (Mn) in the range of from about 300 to 20,000 Da, more preferably in the range of from about 400 to 12000 Da, most preferably from about 1000-8000 Da.

The polycarbonate block of the surface-active agent preferably has a molecular weight (Mn) in the range of from about 200 to 5000 Da, more preferably in the range of from about 200 to 4000 Da, most preferably from about 300 to 3000 Da, especially from about 500 to 2000 Da.

The polyether block of the surface-active agent preferably has a molecular weight (Mn) in the range of from about 100 to 20,000 Da, more preferably of from about 200 to 10,000 Da, most preferably from about 200 to 6000 Da.

The Mn and hence the PDI of the polymers produced by the processes of the invention may be measured using Gel Permeation Chromatography (GPC). For example, the GPC may be measured using an Agilent™ 1260 Infinity GPC machine with two Agilent™ PLgel μ-m mixed-D columns in series. The samples may be measured at room temperature (293K) in THF with a flow rate of 1 mL/min against narrow polystyrene standards (e.g., polystyrene low EasiVials supplied by Agilent™ Technologies with a range of Mn from 405 to 49,450 g/mol). Optionally, the samples may be measured against poly(ethylene glycol) standards, such as polyethylene glycol EasiVials supplied by Agilent™ Technologies.

The polycarbonate blocks of the surface-active agent may have at least 50% carbonate linkages, preferably at least 60% carbonate linkages, preferably at least 70% carbonate linkages, preferably at least 76% carbonate linkages, preferably at least 80% carbonate linkages, more preferably at least 85% carbonate linkages, at least 90% carbonate linkages or at least 95% carbonate linkages.

The polycarbonate blocks of the surface-active agent may also comprise ether linkages. The polycarbonate blocks may have less than 50% ether linkages, preferably less than 40% ether linkages, preferably less than 30% ether linkages, preferably less than 24% ether linkages, preferably less than 20% ether linkages, more preferably less than 15% ether linkages, less than 10% ether linkages, less than 5% ether linkages, less than 3% ether linkages or less than 1% ether linkages.

For the avoidance of doubt, where the polycarbonate blocks comprise ether linkages, the polycarbonate blocks will not solely comprise P repeat units of formula

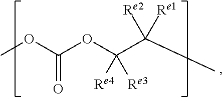

i.e., solely carbonate linkages, but will instead comprise a mixture of both carbonate linkages as shown, and ether linkages as shown for the PE block. P is in that case the sum of carbonate linkages and ether linkages in the PC block. Each carbonate or ether linkage comprises a repeat unit that may be derived from an alkylene oxide moiety, i.e.,

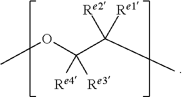

Therefore, where ether linkages are present, P may be considered as the number of repeat alkylene oxide derived moieties in the PC block.

Optionally, the polycarbonate blocks may be generally alternating polycarbonate residues. If the epoxide is asymmetric, then the polycarbonate may have between 0-100% head to tail linkages, preferably between 40-100% head to tail linkages, more preferably between 50-100%. The polycarbonate may have a statistical distribution of head to head, tail to tail and head to tail linkages in the order 1:2:1, indicating a non-stereoselective ring opening of the epoxide, or it may preferentially make head to tail linkages in the order of more than 50%, optionally more than 60%, more than 70%, more than 80%, or more than 90%.

Optionally, the polyether blocks comprises only ether linkages. Typically, the polyether block is at least 90% derived, typically, at least 95% derived, more typically, at least 99%, most typically, 100% derived from epoxides.

Typically, the polyether blocks have less than 40% carbonate linkages, typically, less than 30% carbonate linkages, typically, less than 20% carbonate linkages, more typically, less than 10% carbonate linkages, most typically less than 5%, less than 2% or less than 1% carbonate linkages.

The polyether blocks may have 0% carbonate linkages. For example, the polyether blocks may have from about 0% to about 40% carbonate linkages, from about 0% to about 30% carbonate linkages, from about 0% to about 20% carbonate linkages, from about 0% to about 10% carbonate linkages, from about 0% to about 5% carbonate linkages, from about 0% to about 2% carbonate linkages, or from about 0% to about 1% carbonate linkages.

For the avoidance of doubt, where the polyether blocks comprises carbonate linkages, the polyether blocks will not solely comprise Q repeat units of formula

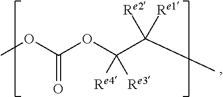

i.e., solely ether linkages, but will instead comprise a mixture of both ether linkages as shown, and carbonate linkages as shown for the PC blocks. Q is in that case the sum of ether linkages and carbonate linkages in the PE block in question. Each ether or carbonate linkage comprises a repeat unit that may be derived from an alkylene oxide moiety, i.e.,

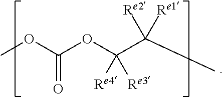

Therefore, where carbonate linkages are present in the PE blocks, Q may be considered as the number of repeat alkylene oxide derived moieties in the PE block in question.

Typically, the polycarbonate blocks are derived from epoxide and CO₂. More typically, epoxide and CO₂ provide at least 70% of the residues in each block, especially, at least 80% of the residues in each block, more especially, at least 90% of the residues in each block. Most especially, in the polycarbonate blocks at least 95% of the residues in each block are residues of epoxide and CO₂. Most typically, the polycarbonate blocks include ethylene oxide and/or propylene oxide residues and optionally butylene oxide. At least 30% of the epoxide residues of the polycarbonate blocks may be ethylene oxide or propylene oxide residues, typically, at least 50% of the epoxide residues of the polycarbonate blocks are ethylene oxide or propylene oxide residues, more typically, at least 75% of the epoxide residues of the polycarbonate blocks are ethylene oxide or propylene oxide residues, most typically, at least 90% of the epoxide residues of the polycarbonate blocks are ethylene oxide or propylene oxide residues.

Typically, the polycarbonate blocks are derived from CO₂ i.e., the carbonates incorporate CO₂ residues. Typically, the polycarbonate blocks have between 70-100% carbonate linkages, more typically, 80-100%, most typically, 90-100%.

The value of P and the value of Q in Formula I may be adapted as appropriate for the end use.

For an oil-in-water application preferably the ratio of Q to P is greater than 1:1. For example, the ratio of Q to P may be from 5:1 to 1:1, or from 2:1 to 1:1. By having P less than or equal to Q the solubility of the surface-active agent in water is improved.

The surface-active agent may be water-soluble.

The surface-active agent may have a water solubility of at least about 0.25 g/ml at standard temperature and pressure (STP). Water solubility may be determined by adding the surface-active agent to water at the specified concentration and then visibly observing whether the surface-active agent dissolves.

For a water-in-oil application preferably the ratio of P to Q is greater than 1:1. By having Q less than or equal to P the solubility of the surface-active agent in oil is improved.

For the majority of applications a P:Q ratio of 2:1 or less is desirable.

The surface-active agent may be oil-soluble.

The surface-active agent may have an oil solubility of at least about 0.25 g/ml at standard temperature and pressure (STP). Oil solubility may be determined by adding the surface-active agent to the chosen oil at the specified concentration and then visibly observing whether the surface-active agent dissolves.

For example, the surface-active agent may have a solubility in octanol of at least about 0.25 g/ml at STP.

For an oil-in-water application when the PC blocks derive from or derive primarily from, ethylene oxide the P:Q ratio is preferably such that the carbonate blocks contribute up to about 60% w/w, preferably up to about 50% w/w of the composition. We find that in this case, the more preferred surface-active agents in accordance with the invention for oil-in water applications comprise 20-60 wt % carbonate blocks. Preferably when the PC blocks derive from propylene oxide, or derived primarily from, the P:Q ratio is such that the carbonate blocks contribute up to about 70% w/w, preferably up to about 50% w/w, of the composition. We find that in this case, the more preferred surface-active agents in accordance with the invention for oil-in water applications comprise 30-70 wt % carbonate blocks. Controlling the w/w carbonate content permits control over water solubility, renewable carbon content and amphiphilicity, which relates to surface active performance.

For a water-in-oil application when the PC blocks derive from or derived primarily from, ethylene oxide the P:Q ratio is preferably such that the carbonate blocks contribute at least about 40% w/w, preferably at least about 50% w/w of the composition. We find that in this case, the more preferred surface-active agents in accordance with the invention for water-in-oil applications comprise 40-80 wt % carbonate blocks. Preferably when the PC blocks derive from propylene oxide, or derived primarily from, the P:Q ratio is such that the carbonate blocks contribute at least about 30% w/w, preferably at least about 50% w/w, of the composition. We find that in this case, the more preferred surface-active agents in accordance with the invention for water-in-oil applications comprise 40-80 wt % carbonate blocks. Controlling the w/w carbonate content permits control over water solubility, renewable carbon content and amphiphilicity, which relates to surface active performance.

It will be apparent to the skilled addressee that when selecting the P:Q ratio to control chain hydrophobicity, the selected ratios may (or may not) differ between, say, PC blocks derived from ethylene oxide on the one hand, and from propylene oxide on the other. A PC block derived from propylene oxide will have a higher molecular weight than a PC block derived from ethylene oxide and therefore for a given chain length and w/w % carbonate content will contribute fewer blocks in the chain relative to a PC block derived from ethylene oxide and otherwise having the same chain length and w/w % carbonate content. In itself this would tend to reduce the overall hydrophobicity of the chain, but there is a trade-off because the hydrophobicity of each PC block derived from propylene oxide will be somewhat higher than that of each PC block derived from ethylene oxide on account of the additional methyl group. Satisfactory control of the P:Q ratio ideally takes account of these factors.

The independent values of P and Q are typically from 1 to 50, from 1 to 45, from 1 to 40, from 1 to 35, from 1 to 30, from 1 to 25, from 1 to 20, preferably from 1 to 15.

A is derived from a polyfunctional starter compound of the formula;

Y(R^{Y})^{a}

Y can be any group which can have 2 or more —R^{Y} groups attached to it. Thus, Y may be selected from optionally substituted alkylene, alkenylene, alkynylene, heteroalkylene, heteroalkenylene, heteroalkynylene, cycloalkylene, cycloalkenylene, hererocycloalkylene, heterocycloalkenylene, arylene, heteroarylene, or Y may be a combination of any of these groups, for example Y may be an alkylarylene, heteroalkylarylene, heteroalkylheteroarylene or alkylheteroarylene group. Optionally Y is alkylene, heteroalkylene, arylene, or heteroarylene.

It will be appreciated that a is an integer which is at least 2. Optionally a is in the range of from 2 to 8, or from 2 to 6.

Each R^{Y} may be —OH, —NHR′, —SH, —C(O)OH, —P(O)(OR′)(OH), —PR′(O)(OH)₂ or —PR′(O)OH, optionally R^{Y} is selected from —OH, —NHR′ or —C(O)OH, optionally each R^{Y} is —OH, —C(O)OH or a combination thereof (e.g. each R^{Y} is —OH).

R′ may be H, or optionally substituted alkyl, heteroalkyl, aryl, heteroaryl, cycloalkyl or heterocycloalkyl, optionally R′ is H or optionally substituted alkyl.

A is typically derived from the starter compound by removal of two or more hydrogen atoms and subsequent polymerisation from the deprotonated derivatives.

According to a second aspect of the invention there is also provided a process for producing a surface-active agent according to the first aspect of the invention the process comprising the steps of (i) reacting carbon dioxide and an epoxide in the presence of a carbonate catalyst, and a polyfunctional starter compound to form a polycarbonate compound and (ii) reaction of the polycarbonate compound of step (i) with an epoxide and an ether catalyst to produce the surface-active agent according to the first aspect of the invention.

The epoxide may be selected from ethylene oxide, propylene oxide, butylene oxide, pentylene oxide, hexylene oxide, glycidyl ethers, glycidyl esters or glycidyl carbonates or a mixture of two or more thereof. Typically, the epoxide is selected from ethylene oxide, propylene oxide or a mixture thereof, preferably ethylene oxide.

The carbonate catalyst may be heterogeneous or homogeneous.

The carbonate catalyst may be a mono-metallic, bimetallic, or multi-metallic homogeneous complex or it may be a non-metallic Lewis acid-base pair (for example based upon combination of boranes and ammonium salts, as disclosed in patents WO2016203408, WO2020121262, WO2021005470). The carbonate catalyst may be a heterogeneous catalyst, such as a metal organic framework (MOF), which may be derived from metals such as Scandium or Aluminium, such as those described in WO2021123761.

The carbonate catalyst may comprise phenol or phenolate ligands.

Typically, the carbonate catalyst may be a bimetallic complex comprising phenol or phenolate ligands. The two metals may be the same or different.

The carbonate catalyst may be a catalyst of formula (IV):

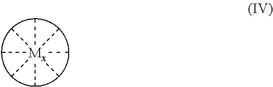

wherein:
M is a metal cation represented by M-(L)ᵥ;
x is an integer from 1 to 4, preferably x is 1 or 2;

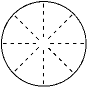

is a multidentate ligand or plurality of multidentate ligands;
L is a coordinating ligand, for example, L may be a neutral ligand, or an anionic ligand that is capable of ring-opening an epoxide;
v is an integer that independently satisfies the valency of each M, and/or the preferred coordination geometry of each M or is such that the complex represented by formula (IV) above has an overall neutral charge. For example, each v may independently be 0, 1, 2 or 3, e.g., v may be 1 or 2. When v>1, each L may be different.

The term multidentate ligand includes bidentate, tridentate, tetradentate and higher dentate ligands. Each multidentate ligand may be a macrocyclic ligand or an open ligand.

Such catalysts include those in WO2010022388 (metal salens and derivatives, metal porphyrins, corroles and derivatives, metal tetraaza annulenes and derivatives), WO2010028362 (metal salens and derivatives, metal porphyrins, corroles and derivatives, metal tetraaza annulenes and derivatives), WO2008136591 (metal salens), WO2011105846 (metal salens), WO2014148825 (metal salens), WO2013012895 (metal salens), EP2258745A1 (metal porphyrins and derivatives), JP2008081518A (metal porphyrins and derivatives), CN101412809 (metal salens and derivatives), WO2019126221 (metal aminotriphenol complexes), U.S. Pat. No. 9,018,318 (metal beta-diiminate complexes), U.S. Pat. No. 6,133,402A (metal beta-diiminate complexes) and U.S. Pat. No. 8,278,239 (metal salens and derivatives), the entire contents of which, especially, insofar as they relate to suitable carbonate catalysts for the reaction of CO₂ and epoxide, in the presence of a starter and optionally a solvent as defined herein are incorporated herein by reference.

Preferably the carbonate catalysts are bimetallic phenolate catalysts. Suitable bimetallic phenolate complexes are those described in WO2009/130470, WO2013/034750, WO2016/012786, WO2016/012785, WO2012037282 and WO2019048878A1, the entire contents of which, especially, insofar as they relate to suitable carbonate catalysts for the reaction of CO₂ and epoxide, in the presence of a starter and optionally a solvent as defined herein are incorporated herein by reference.

The ether catalyst may be any catalyst suitable for polymerising epoxides to form polyethers.

Suitable ether catalysts include DMC catalysts, metal alkoxides, boron-based catalysts such as BF₃ or BH₃, anionic catalysts such as KOH, cationic, acidic or superacidic catalysts (such as HSbF₆, CF₃SO₃H), PF₅, activated monomer catalysts, organic catalysts such as imidazole or phosphazene reagents and metallosalenate catalysts. Preferably the ether catalyst is a DMC catalyst. Examples of DMC catalysts which can be used in the process of the invention include those described in U.S. Pat. Nos. 3,427,256, 5,536,883, 6,291,388, 6,486,361, 6,608,231, 7,008,900, 5,482,908, 5,780,584, 5,783,513, 5,158,922, 5,693,584, 7,811,958, 6,835,687, 6,699,961, 6,716,788, 6,977,236, 7,968,754, 7,034,103, 4,826,953, 4,500,704, 7,977,501, 9,315,622, EP-A-1568414, EP-A-1529566, and WO 2015/022290, the entire contents of which are incorporated by reference.

The ratio of the carbonate catalyst to the ether catalyst may be in the range of from about 300:1 to about 1:100, for example, from about 120:1 to about 1:75, such as from about 40:1 to about 1:50, e.g. from about 30:1 to about 1:30 such as from about 20:1 to about 1:1, for example from about 10:1 to about 2:1, e.g. from about 5:1 to about 1:5. These ratios are mass ratios.

The process may be carried out in a one pot reactor or may be a dual reactor process.

Hence, according to a third aspect of the invention there is also provided a process for producing a surface-active agent according to the first aspect of the invention in a multiple reactor system; the system comprising a first and second reactor wherein a first reaction takes place in the first reactor and a second reaction takes place in the second reactor; wherein the first reaction is the reaction of a carbonate catalyst with CO₂ and epoxide, in the presence of a polyfunctional starter compound, and optionally a solvent, to produce a polycarbonate compound and the second reaction is the semi-batch or continuous reaction of an ether catalyst with the polycarbonate compound of the first reaction and epoxide to produce the surface-active agent according to the first aspect of the invention.

Typically, the reaction mixture from the first step contains less than 5% CO₂ by weight of the reaction mixture prior to the second step, preferably less than 2.5%, such as less than 1.0%, less than 0.5% or less than 0.1%. Typically, the second step is carried out without the independent addition of CO₂, however it can be carried out under a pressure of CO₂. The polyether block produced in the second step may have less than 40% carbonate linkages, preferably less than 30% carbonate linkages or less than 20% carbonate linkages, more preferably less than 10%, less than 5%, less than 2% or less than 1% carbonate linkages. Preferably the polyether block produced in the second step is substantially free from carbonate linkages.

Typically, therefore the second step is carried out substantially in the absence of CO₂.

Accordingly, by substantially in the absence of CO₂ is meant that the second step is carried out in the presence of less than 4% CO₂ by weight, preferably less than 2%, such as less than 1.0%, less than 0.5% or less than 0.1% by weight of total reactants, catalyst, and products in the second step.

Adding the components in the separate steps may be useful to increase activity of the catalysts and may lead to a more efficient process, compared with a process in which all of the materials are provided at the start of the process. Large amounts of some of the components present throughout the process may reduce efficiency of the catalysts. Reacting this material in separate steps may prevent this reduced efficiency of the catalysts and/or may optimise catalyst activity. The reaction conditions of each step can be tailored to optimise the reactions for each catalyst.

The ether catalyst may be pre-activated prior to addition in the second step. Such pre-activation may be achieved by mixing one or both catalysts with epoxide (and optionally other components). Pre-activation of the ether catalyst is useful as it enables safe control of the reaction (preventing uncontrolled increase of unreacted monomer content) and removes unpredictable activation periods.

Although typically any residual CO₂ from the first step may be removed from the crude reaction product of the first step prior to commencement of the second step such that the second step is carried out without CO₂, it will be appreciated that a small amount of CO₂ may be present in the reaction mixture in the second step as an unused reagent of the first step. Alternatively, both steps may be carried out under a pressure of CO₂.

The reactions of the present invention may be carried out in the presence of a solvent; however, it will also be appreciated that the processes may also be carried out in the absence of a solvent. When a solvent is present, it may be toluene, hexane, t-butyl acetate, diethyl carbonate, dimethyl carbonate, dioxane, dichlorobenzene, methylene chloride, propylene carbonate, ethylene carbonate, acetone, ethyl acetate, propyl acetate, n-butyl acetate, tetrahydrofuran (THF), etc. The solvent may be toluene, hexane, acetone, ethyl acetate and n-butyl acetate.

Adding the components in the separate reactions and reactors may be useful to increase activity of the catalysts and may lead to a more efficient process, compared with a process in which all of the materials are provided at the start of one reaction. Large amounts of some of the components present throughout the reaction may reduce efficiency of the catalysts. Reacting this material in separate reactors may prevent this reduced efficiency of the catalysts and/or may optimise catalyst activity. The reaction conditions of each reactor can be tailored to optimise the reactions for each catalyst.

Additionally, not loading the total amount of each component at the start of the reaction and having the catalyst for the first reaction in a separate reactor to the catalyst for the second reaction, may lead to even catalysis, and more uniform polymer products. This in turn may lead to polymers having a narrower molecular weight distribution, desired ratio, and distribution along the chain of ether to carbonate linkages, and/or improved stability.

Having the reactions with the two different catalysts separate and mixing only certain components in the first reaction and adding the remainder in the second reaction may also be useful, for example by adding a pre-activated ether catalyst or adding the reaction mixture to a pre-activated ether catalyst.

Preferred ether catalysts and carbonate catalysts are as for the second aspect of the invention.

The first reaction may be carried out in more than one reactor that feeds the crude reaction mixture into the second reaction, and reactor, continuously. Preferably, the second reaction is run in a continuous mode.

The product of the first reaction may be stored for subsequent later use in the second reactor.

The two reactors may be located in a series, or the reactors may be nested. Each reactor may individually be a stirred tank reactor, a loop reactor, a tube reactor, or other standard reactor design.

### Definitions

The term “alkyl,” as used herein, unless otherwise defined refers to saturated, linear- or branched-chain hydrocarbon radicals derived by removal of a single hydrogen atom from an aliphatic moiety. An alkyl group may be a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Preferably, an alkyl group is a C₁₋₁₅ alkyl, preferably a C₁₋₁₂ alkyl, more preferably a C₁₋₁₀ alkyl, even more preferably a C₁₋₃ alkyl, even more preferably a C₁₋₆ alkyl group.

Unless defined otherwise herein, an ester group is optionally —OC(O)R¹— or —C(O)OR¹— wherein R¹ can be an aliphatic, heteroaliphatic, alicyclic, heteroalicyclic, aryl or heteroaryl group. R¹ may be unsubstituted aliphatic, alicyclic or aryl. Optionally R¹ is methyl, ethyl, propyl, or phenyl. The ester group may be terminated by an aliphatic, heteroaliphatic, alicyclic, heteroalicyclic, aryl or heteroaryl group. It will be appreciated that if R¹ is hydrogen, then the group defined by —OC(O)R¹— or —C(O)OR¹— will be a carboxylic acid group.

A carbonate group is optionally —OC(O)OR², wherein R² can be hydrogen, an aliphatic, heteroaliphatic, alicyclic, heteroalicyclic, aryl or heteroaryl group. R² may be optionally substituted aliphatic, alicyclic or aryl. Optionally R² is hydrogen, methyl, ethyl, propyl, butyl (for example n-butyl, isobutyl, or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl, cyclohexyl, benzyl or adamantyl. Optionally R² is methyl, ethyl, propyl, or phenyl. It will be appreciated that if R² is hydrogen, then the group defined by —OC(O)OR² will be a carbonic acid group.

A carbonate functional group is —OC(O)O— and may be derived from a suitable source. Generally, it is derived from CO₂.

An ether group is optionally —OR³ wherein R³ can be an aliphatic, heteroaliphatic, alicyclic, heteroalicyclic, aryl or heteroaryl group. R³ may be unsubstituted aliphatic, alicyclic or aryl. Optionally R³ is methyl, ethyl, propyl, butyl (for example n-butyl, isobutyl, or tert-butyl), phenyl, pentafluorophenyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, trifluoromethyl or adamantyl. Optionally R³ is methyl, ethyl, propyl, or phenyl.

As used herein, the term “optionally substituted” means that one or more of the hydrogen atoms in the optionally substituted moiety is replaced by a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable compounds. The term “stable”, as used herein, refers to compounds that are chemically feasible and can exist for long enough at room temperature i.e. (16-25° C.) to allow for their detection, isolation and/or use in chemical synthesis.

Substituents may be depicted as attached to a bond that crosses a bond in a ring of the depicted molecule. This convention indicates that one or more of the substituents may be attached to the ring at any available position (usually in place of a hydrogen atom of the structure). In cases where an atom of a ring has two substitutable positions, two groups (either the same or different) may be present on that atom.

Preferred optional substituents for use in the present invention include, but are not limited to, halogen, hydroxy, nitro, carboxylate, carbonate, alkoxy, aryloxy, alkylthio, arylthio, heteroaryloxy, alkylaryl, amino, amido, imine, nitrile, silyl, silyl ether, ester, sulfoxide, sulfonyl, acetylide, phosphinate, sulfonate or optionally substituted aliphatic, heteroaliphatic, alicyclic, heteroalicyclic, aryl or heteroaryl groups (for example, optionally substituted by halogen, hydroxy, nitro, carbonate, alkoxy, aryloxy, alkylthio, arylthio, amino, imine, nitrile, silyl, sulfoxide, sulfonyl, phosphinate, sulfonate or acetylide).

Particularly preferred optional substituents for use in the present invention are selected from nitro, C₁₋₁₂ alkoxy (e.g., OMe, OEt, O′Pr, OⁿBu, O^{t}Bu), C₆₋₁₈ aryl, C₂₋₁₄ heteroaryl, C₂₋₁₄ heteroalicyclic, C₁₋₆ alkyl, C₁₋₆ haloalkyl, F, Cl, Br, I and OH, wherein in each of said C₁₋₁₂ alkoxy, C₆₋₁₈ aryl, C₂₋₁₄ heteroaryl, C₂₋₁₄ heteroalicyclic, C₁₋₆ alkyl and C₁₋₆ haloalkyl group may be optionally substituted by an optional substituent as defined herein.

The term “continuous” used herein can be defined as the mode of addition of materials or may refer to the nature of the reaction method as a whole.

In terms of continuous mode of addition, the relevant materials are continually or constantly added during the course of a reaction. This may be achieved by, for example, adding a stream of material with either a constant flow rate or with a variable flow rate. In other words, the one or more materials are added in an essentially non-stop fashion. It is noted, however, that non-stop addition of the materials may need to be briefly interrupted for practical considerations, for example to refill or replace a container of the materials from which these materials are being added.

In terms of a whole reaction being continuous, the reaction may be conducted over a long period of time, such as a number of days, weeks, months, etc. In such a continuous reaction, reaction materials may be continually topped-up and/or products of the reaction may be tapped-off. It will be appreciated that although catalysts may not be consumed during a reaction, catalysts may in any case require topping-up, since tapping-off may deplete the amount of catalyst present.

A continuous reaction may employ continuous addition of materials.

A continuous reaction may employ a discontinuous (i.e., batch-wise or semi batch-wise) addition of materials

The term series used herein refers to when two or more reactors are connected so that the crude reaction mixture can flow from the first reactor to the second reactor.

The term nested used herein refers to when two or more reactors are configured so that one is located within the other. For example, in the present invention, when the second reactor is located inside the first reactor, allowing the conditions of both reactors to influence the other.

### EXAMPLES

Compounds in accordance with the invention were prepared by a sequential reaction scheme as follows:

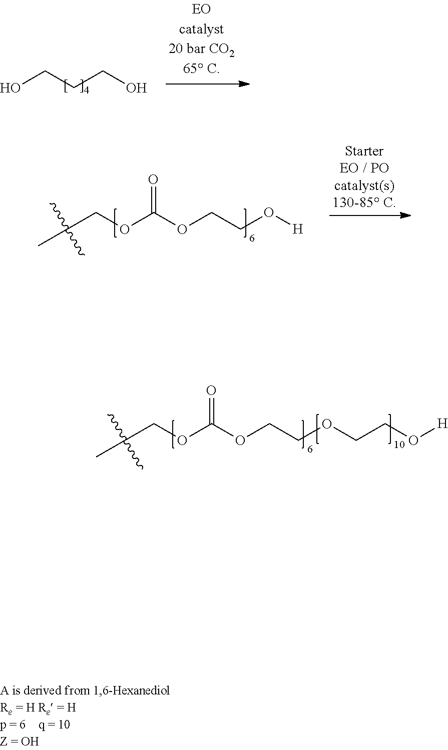

The examples provided in Example 1 relate to low molecular weight end-products, and the examples provided in Example 2 relate to high molecular weight end-products.

### Example 1

### Reaction 1

Diol starter was charged to the cold, dry base of a 100 mL Parr™ high pressure reactor system. The charged vessel was dried by heating to 100° C. under vacuum (approx. 1 mbar) and held for 60 mins before cooling and filling with low pressure CO₂.

Catalyst (1) (prepared according to Example 2 of WO2017/037441) was added to the reactor. This was vacuum-purged for <5 mins at room temperature before back-filling with low pressure CO₂.

To the mixture was added EO. The mixture was stirred and pressurized to approximately half target-pressure. The mixture was then heated to target temperature and pressure held at constant temperature and target pressure using a mass-flow controller.

At the end of the desired reaction time, the mixture was cooled to <10° C. and vented through an acid scrubber system. EO and anhydrous ethyl acetate were added to the cold stirring mixture before transferring into an intermediate holding vessel.

### Reaction 2

Pre-dried mono-ol starter and a DMC composed of zinc hexacyanocobaltate and tert-butyl alcohol was added to the cold, base of a 100 mL Parr™ high pressure reactor system. The starter was held under vacuum (approx. 1 mbar) for approximately 2 mins before filling with low pressure N₂ and then anhydrous ethyl acetate (15 mL) via syringe.

This DMC/starter/ethyl acetate mixture was then heated with 130° C. with stirring and the DMC activated with 2 slugs of approximately 0.3 g PO (1 mL/min set-point). After activation (as evidenced by pressure drops) the external heater was removed, optionally the reactor could be pressurized with CO₂, then the mixture was cooled to the target addition temperature whilst continually slowly adding PO (set 0.1 mL/min) [approximately 1.2 g PO total].

Upon reaching the target temperature, the mixture from Reaction 1 was added onto the active DMC system over approximately 60-90 mins. Once addition of the mixture was complete, the mixture was left to “cook-out” for several hours before cooling, venting and taking samples for analysis by NMR and GPC.

The results are displayed in Tables 1 to 3 below.

TABLE 1
Reaction 1 experimental conditions/results

| | Econic | | Starter | | Temp/ | Pressure/ | Time/ |
|---|---|---|---|---|---|---|---|
| Entry | Cat/g | Starter | mass/g | EO/mL | ° C. | barg | h |
| 1 | 0.18 | 1,6- | 2.8 | 30 | 75 | 20 | 16 |
| | | Hexanediol | | | | | |
| 2 | 0.18 | 1,6- | 3.0 | 30 | 75 | 20 | 16 |
| | | Hexanediol | | | | | |
| 3 | 0.22 | 1,6- | 2.7 | 30 | 75 | 20 | 16 |
| | | Hexanediol | | | | | |

TABLE 2
Reaction 2 experimental conditions

| | | | | Feed | | Reactor |
|---|---|---|---|---|---|---|
| | DMC/ | | Starter | temperature/ | Reactor | Pressure/ |
| Entry | mg | Starter | mass/g | ° C. | gas | barg |
| 1 | 9 | PPG400 | 0.4 | 85 | N₂ | N/A |
| 2 | 9 | PPG400 | 0.4 | 85 | N₂ | N/A |
| 3 | 9 | PPG400 | 0.4 | 85 | N₂ | N/A |

TABLE 3
Reaction 2 results

| | Conversion/ | | PDI | CO₂ | | | Water |
|---|---|---|---|---|---|---|---|
| Entry | % | Mn | (GPC) | wt % | p | q | solubility |
| 1 | 100 | 980 | 1.04 | 17 | 4 | 12 | Y |
| 2 | 100 | 1100 | 1.08 | 20 | 6 | 15 | Y |
| 3 | 100 | 1050 | 1.08 | 24 | 6 | 10 | Y |

### Example 2

### Reaction 1

Diol starter is charged to the cold, dry base of a 600 mL Parr™ high pressure reactor system. The charged vessel is dried by heating to 100° C. under vacuum (approx. 1 mbar) and held for 60 mins before cooling and filling with low pressure CO₂.

Catalyst (1) (prepared according to Example 2 of WO2017/037441) is added to the reactor. This is vacuum-purged for <5 mins at room temperature before back-filling with low pressure CO₂.

The mixture is stirred and pressurized to approximately half target-pressure. The mixture is then heated to target temperature and pressure held at constant temperature and target pressure using a mass-flow controller. To the mixture is added epoxide (either ethylene oxide [EO] or propylene oxide [PO]), either in batch or semi-batch fashion.

At the end of the desired reaction time, the mixture is cooled to <10° C. and vented through an acid scrubber system.

### Reaction 2

Pre-dried mono-ol starter and a DMC composed of zinc hexacyanocobaltate and t-butyl alcohol are added to the cold base of a 600 mL Parr™ high pressure reactor system. The starter+base are held under vacuum (approx. 1 mbar) for approximately 2 mins before filling with low pressure N₂ and then anhydrous ethyl acetate (15 mL) via HPLC pump.

This DMC/starter/ethyl acetate mixture is then heated with 130° C. with stirring and the DMC activated with 2 slugs of approximately 0.3 g EO (1 mL/min set-point). After activation (as evidenced by pressure drops) the external heater is removed, optionally the reactor could be pressurized with CO₂, then the mixture is cooled to the target addition temperature.

Upon reaching the target temperature, the product from Reaction 1 and EO are added onto the active DMC system over approximately 60-90 mins (semi-batch fashion). Once addition of the mixture is complete, the mixture is left to “cook-out” for several hours before cooling, venting and taking samples for analysis by NMR and GPC.

The results are displayed in Tables 4 to 6 below.

TABLE 4
Reaction 1 experimental conditions/results

| | Econic | | Starter | | Temp/ | Pressure/ | Time/ |
|---|---|---|---|---|---|---|---|
| Entry | Cat/g | Starter | mass/g | Epoxide/g | ° C. | barg | h |
| 1 | 0.9 | 1,6- | 45 | EO: 200 | 60 | 14 | 8 |
| | | Hexanediol | | | | | |
| 2 | 0.4 | 1,6- | 18 | EO: 200 | 60 | 14 | 8 |
| | | Hexanediol | | | | | |
| 3 | 0.1 | 1,6- | 5.4 | EO: 100 | 60 | 14 | 8 |
| | | Hexanediol | | | | | |
| 4 | 0.3 | 1,6- | 15 | EO: 300 | 60 | 14 | 8 |
| | | Hexanediol | | | | | |
| 5 | 0.4 | 1,6- | 13.5 | PO: 200 | 60 | 14 | 8 |
| | | Hexanediol | | | | | |

TABLE 5
Reaction 2 experimental conditions

| | | | | | Feed | | Reactor |
|---|---|---|---|---|---|---|---|
| | DMC/ | | Starter | | temperature/ | Reactor | Pressure/ |
| Entry | mg | Starter | mass/g | EO/g | ° C. | gas | barg |
| 1 | 50 | PEG400 | 10 | 340 | 85 | N₂ | N/A |
| 2 | 50 | PEG400 | 10 | 280 | 85 | N₂ | N/A |
| 3 | 50 | PEG400 | 10 | 200 | 85 | N₂ | N/A |
| 4 | 50 | PEG400 | 10 | 210 | 85 | N₂ | N/A |
| 5 | 50 | PEG400 | 10 | 310 | 85 | N₂ | N/A |

TABLE 6
Reaction 2 results

| | Conversion/ | | CO₂ | | |
|---|---|---|---|---|---|
| Entry | % | Mn | wt % | p | q |
| 1 | 100 | 2000 | 25 | 6 | 10 |
| 2 | 100 | 4500 | 29 | 15 | 20 |
| 3 | 100 | 9000 | 24 | 25 | 50 |
| 4 | 100 | 7100 | 37 | 30 | 20 |
| 5 | 100 | 3300 | 20 | 15 | 20 |

The data shown in the examples demonstrates that it is possible using the process of the invention to prepare a range of end products with differing p:q ratios, and with both low and high molecular weights depending on the conditions and reagents selected, and hence it is advantageously possible to tailor the manufacturing process adaptively with due regard to the intended application.

1. A surface-active agent comprising a polycarbonate block polyether of the formula I: 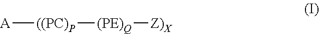
wherein:
A is derived from a polyfunctional starter compound;
PC represents a carbonate block with P repeat units of formula: 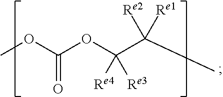
wherein:
R^{e1}, R^{e2}, R^{e3}, and R^{e4} are all H; or
one of R^{e1}, R^{e2}, R^{e3}, and R^{e4} is methyl, ethyl, propyl, butyl, or an ether, ester or carbonate group, and the remaining three of R^{e1}, R^{e2}, R^{e3}, and R^{e4} are all H;
PE represents a polyether block with Q repeat units of formula: 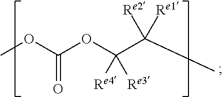
wherein:
R^{e1′}, R^{e2′}, R^{e3′}, and R^{e4′} are all H; or
one of R^{e1′}, R^{e2′}, R^{e3′}, and R^{e4′} is methyl, ethyl, propyl, butyl, or an ether, ester or carbonate group, and the remaining three of R^{e1′}, R^{e2′}, R^{e3′}, and R^{e4′} are all H;
Z is OH, O—R, O—C(O)—R or O—C(O)—O—R;
wherein each R is independently an optionally substituted (including with heteroatoms) straight or branched chain or cyclic alkyl, aryl, aralkyl, alkaryl, alkenyl, alkenaryl, or aralkenyl group;
wherein the value of each P and the value of each Q are each independently from 1 to 50; and
X is 2 or more.

2. The surface-active agent according to claim 1, wherein Z is OH or O—R, wherein R is methyl.

3. The surface-active agent according to claim 1, wherein the value of each P and the value of each Q are independently from 1 to 45, from 1 to 40, from 1 to 35, from 1 to 30, from 1 to 25, from 1 to 20, or from 1 to 15.

4. The surface-active agent according to claim 1, wherein one of R^{e1}, R^{e2}, R^{e3} and R^{e4} is independently selected from methyl or ethyl, and the remaining three of R^{e1}, R^{e2}, R^{e3} and R^{e4} are each H, or wherein each of R^{e1}, R^{e2}, R^{e3} and R^{e4} is H.

5. The surface-active agent according to claim 1, wherein one of R^{e1′}, R^{e2′}, R^{e3′} and R^{e4′} is independently selected from methyl or ethyl, and the remaining three of R^{e1′}, R^{e2′}, R^{e3′} and R^{e4′} are each H, or wherein each of R^{e1′}, R^{e2′}, R^{e3′} and R^{e4′} is H.

6. The surface-active agent according to claim 1, wherein the total surface-active agent has greater than 5 wt % CO₂ incorporation, optionally greater than 10 wt % CO₂ incorporation, optionally greater than 15 wt % CO₂ incorporation, optionally greater than 20 wt % CO₂ incorporation, optionally greater than 21 wt % CO₂ incorporation.

7. The surface-active agent according to a claim 1, wherein the total surface-active agent has 5 to 40 wt % CO₂ incorporation, optionally 10 to 40 wt % CO₂ incorporation, optionally 15 to 40 wt % CO₂ incorporation, optionally 20 to 40 wt % CO₂ incorporation, optionally 10 to 35 wt % CO₂ incorporation, optionally 15 to 30 wt % CO₂ incorporation.

8. The surface-active agent according to claim 1, having a P:Q ratio adapted to provide the surface-active agent with amphiphilicity suitable for an oil-in-water application.

9. The surface-active agent according to claim 8, wherein the ratio of Q to P is greater than 1:1.

10. The surface-active agent according to claim 8, wherein the ratio of Q to P is from 5:1 to 1:1, optionally from 2:1 to 1:1.

11. The surface-active agent according to claim 8 which is water-soluble.

12. The surface-active agent according to claim 11 having water solubility of at least about 0.25 g/ml at STP.

13. The surface-active agent according to claim 8, wherein the PC blocks derive from, or derive primarily from, ethylene oxide and wherein the P:Q ratio is such that the carbonate blocks contribute up to about 60% w/w, optionally up to about 50% w/w of the composition.

14. The surface-active agent according to claim 13, further comprising 20-60 wt % carbonate blocks.

15. The surface-active agent according to claim 8, wherein the PC blocks derive from, or derive primarily from, propylene oxide and wherein the P:Q ratio is such that the carbonate blocks contribute up to about 70% w/w, optionally up to about 50% w/w, of the composition.

16. The surface-active agent according to claim 15, comprising 30-70 wt % carbonate blocks.

17. The surface-active agent according to claim 1, having a P:Q ratio adapted to provide the surface-active agent with amphiphilicity suitable for a water-in-oil application.

18. The surface-active agent according to claim 17, wherein the ratio of P to Q is greater than 1:1.

19. The surface-active agent according to claim 17, which is oil-soluble.

20. The surface-active agent according to claim 19, having an oil solubility of at least about 0.25 g/ml at STP.

21. The surface-active agent according to claim 19, having solubility in octanol of at least about 0.25 g/ml at STP.

22. The surface-active agent according to claim 17, wherein the PC blocks derive from, or derive primarily from, ethylene oxide and wherein the P:Q ratio is such that the carbonate blocks contribute at least about 40% w/w, optionally at least about 50% w/w of the composition.

23. The surface-active agent according to claim 17, wherein the PC blocks derive from, or derive primarily from, propylene oxide and wherein the P:Q ratio is such that the carbonate blocks contribute at least about 30% w/w, optionally at least about 50% w/w of the composition.

24. The surface-active agent according to claim 22, further comprising 40-80 wt % carbonate blocks.

25. The surface-active agent according to claim 1, wherein the P:Q ratio is 2:1 or lower.

26. The surface-active agent according to claim 1, wherein the polyether blocks have less than 40% carbonate linkages, optionally less than 30%, less than 20%, less than 10%, less than 5%, less than 2% or less than 1% carbonate linkages.

27. The surface-active agent according to claim 26, wherein the polyether blocks have 0% carbonate linkages.

28. A method of producing a surface-active agent according to claim 1, wherein the method comprises the steps of
(i) reacting carbon dioxide and an epoxide in the presence of a carbonate catalyst, and a polyfunctional starter compound to form a polycarbonate compound and
(ii) reacting of the polycarbonate compound of step (i) with an epoxide and an ether catalyst to produce the surface-active agent according to claim 1.

29. A method of producing a surface-active agent according to claim 1 in a multiple reactor system; the system comprising a first and second reactor wherein a first reaction takes place in the first reactor and a second reaction takes place in the second reactor; wherein the first reaction is the reaction of a carbonate catalyst with CO₂ and epoxide, in the presence of a polyfunctional starter compound, and optionally a solvent, to produce a polycarbonate compound and the second reaction is the semi-batch or continuous reaction of an ether catalyst with the polycarbonate compound of the first reaction and epoxide to produce the surface-active agent according to claim 1.

30. The method of claim 28, wherein the carbonate catalyst is a bimetallic phenolate complex.

31. The method of claim 28, wherein the ether catalyst is a DMC catalyst.

32. (canceled)
